(19) United States
(12) Patent Application Publication
(10) Pub. No.: US 2026/0161315 A1
(43) Pub. Date: Jun. 11, 2026

(54) System and Method for Autonomous Gearshift Deduplication in an Storage System

(71) Applicant: Dell Products L.P., Round Rock, TX (US)

(72) Inventors: Maher Kachmar, Dearborn Heights, MI (US); Vamsi Vankamamidi, Hopkinton, MA (US)

(21) Appl. No.: 18/973,498

(22) Filed: Dec. 9, 2024

(51) Int. Cl. G06F 3/06

(52) U.S. Cl. CPC G06F 3/0641; G06F 3/0608; G06F 3/0671

(57) ABSTRACT

A method, computer program product, and computing system for tracing a variable set of deduplication metrics for one or more deduplication data sets, applying a regression-based machine learning (ML) model to the variable set of deduplication metrics, and generating a weighted deduplication score and a weighted compression score for each data sample. The method may further include selecting one or more of a compression algorithm and a deduplication parameter based on one or more of the weighted deduplication score and the weighted compression score. A flushing manager may be used to perform in-line deduplication on one or more selections of front-end IO write data and to apply one or more of the selected compression algorithm and the selected deduplication parameter.

### BACKGROUND

Storing and safeguarding electronic content may be beneficial in modern business and elsewhere. Accordingly, various methodologies may be employed to protect and distribute such electronic content.

Deduplication is a data reduction technique used to eliminate redundant copies of data. Its aim is that only unique instances of data are stored, significantly reducing storage requirements and improving efficiency. By storing only unique pieces of data, deduplication may minimize the total storage capacity required, thereby allowing organizations to reduce costs for physical storage hardware, maintenance, and power consumption. Further, when performing any kind of system backup, replication, or disaster recovery process, deduplication may be used to reduce the amount of data that needs to be transmitted over the network, which in turn may lead to faster data transfer and lower bandwidth requirements. Additionally, deduplication may allow organizations to make better use of their existing physical infrastructure because more data can be stored without having to expand storage capacity. This is particularly important as data volumes grow exponentially, especially in environments like cloud storage or virtualized infrastructures.

However, deduplication inherently involves frequent read, write, and metadata update operations, which may accelerate wear on storage media, sometimes referred to as “drive wear”. This is especially true of “late” or “background” deduplication, which refers to a deduplication process where data is first written to storage without performing deduplication in real-time. Deduplication occurs later as a separate, background task. This approach contrasts with in-line deduplication, where data is deduplicated before or as it is written to the storage system.

As such, despite the many benefits provided by implementing deduplication, there is still a need to address the gradual degradation of storage drives, particularly solid-state drives (SSDs), due to the high write and erase cycles often associated with the deduplication process.

### SUMMARY OF DISCLOSURE

In one example implementation, a computer-implemented method executed on a computing device may include, but is not limited to, tracing a variable set of deduplication metrics for one or more deduplication data sets, applying a regression-based machine learning (ML) model to the variable set of deduplication metrics in order to generate one or more of a weighted deduplication score and a weighted compression score for each data set of the one or more deduplication data sets, and selecting one or more of a compression algorithm and a deduplication parameter based on one or more of the weighted deduplication score and the weighted compression score. The method may further include using a flushing manager to perform in-line deduplication on one or more selections of front-end IO write data and to apply one or more of the selected compression algorithm and the selected deduplication parameter.

One or more of the following example features may be included. The regression-based ML model may be configured to generate one or more of the weighted deduplication score and the weighted compression score for each data set of the one or more deduplication data sets. Tracing may occur one or more of at the end of an active flushing cycle, and at the end of a background deduplication cycle. In response to generating one or more of the weighted deduplication score and the weighted compression score, the method may further include persisting one or more of the generated weighted deduplication score and the generated weighted compression score in a metadata cache following at least one of the active flushing cycle or the background deduplication cycle. The regression-based ML model may be configured to integrate with the tracing process by recording one or more of a deduplication hit ratio, a compression yield ratio, and an overwrite rate. The variable set of deduplication metrics may be related to one or more extents of back-end IO write data flushed from front-end IO write data. The variable set of deduplication metrics may include one or more of a deduplication ratio and a compression ratio. The variable set of deduplication metrics may include one or more of: timestamps, metadata addresses, a number of flushes executed within the predefined time period, a metadata retention rate, a data integrity validation rate, and a recovery time.

In another example implementation, a computer program product resides on a computer readable medium that has a plurality of instructions stored on it. When executed by a processor, the instructions may cause the processor to perform operations that include, but are not limited to, tracing a variable set of deduplication metrics for one or more deduplication data sets, applying a regression-based machine learning (ML) model to the variable set of deduplication metrics in order to generate one or more of a weighted deduplication score and a weighted compression score for each data set of the one or more deduplication data sets, and selecting one or more of a compression algorithm and a deduplication parameter based on one or more of the weighted deduplication score and the weighted compression score. The instructions may also cause the processor to use a flushing manager to perform in-line deduplication on one or more selections of front-end IO write data and to apply one or more of the selected compression algorithm and the selected deduplication parameter.

One or more of the following example features may be included. The regression-based ML model may be configured to generate one or more of the weighted deduplication score and the weighted compression score for each data set of the one or more deduplication data sets. Tracing may occur one or more of at the end of an active flushing cycle, and at the end of a background deduplication cycle. In response to generating one or more of the weighted deduplication score and the weighted compression score, the method may further include persisting one or more of the generated weighted deduplication score and the generated weighted compression score in a metadata cache following at least one of the active flushing cycle or the background deduplication cycle. The regression-based ML model may be configured to integrate with the tracing process by recording one or more of a deduplication hit ratio, a compression yield ratio, and an overwrite rate. The variable set of deduplication metrics may be related to one or more extents of back-end IO write data flushed from front-end IO write data. The variable set of deduplication metrics may include one or more of a deduplication ratio and a compression ratio.

In another example implementation, a computing system includes at least one processor and at least one memory architecture coupled with the at least one processor, where the at least one processor may be configured to trace a variable set of deduplication metrics for one or more deduplication data sets, apply a regression-based machine learning (ML) model to the variable set of deduplication metrics in order to generate one or more of a weighted deduplication score and a weighted compression score for each data set of the one or more deduplication data sets, and select one or more of a compression algorithm and a deduplication parameter based on one or more of the weighted deduplication score and the weighted compression score. The instructions may also cause the processor to use a flushing manager to perform in-line deduplication on one or more selections of front-end IO write data and to apply one or more of the selected compression algorithm and the selected deduplication parameter.

One or more of the following example features may be included. The regression-based ML model may be configured to generate one or more of the weighted deduplication score and the weighted compression score for each data set of the one or more deduplication data sets. Tracing may occur one or more of at the end of an active flushing cycle, and at the end of a background deduplication cycle. In response to generating one or more of the weighted deduplication score and the weighted compression score, the method may further include persisting one or more of the generated weighted deduplication score and the generated weighted compression score in a metadata cache following at least one of the active flushing cycle or the background deduplication cycle. The regression-based ML model may be configured to integrate with the tracing process by recording one or more of a deduplication hit ratio, a compression yield ratio, and an overwrite rate. The variable set of deduplication metrics may be related to one or more extents of back-end IO write data flushed from front-end IO write data. The variable set of deduplication metrics may include one or more of a deduplication ratio and a compression ratio.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a gearshift deduplication process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of the gearshift deduplication process of FIG. 1 according to one or more example implementations of the disclosure; and

FIG. 4 is an example diagrammatic view of the gearshift deduplication process of FIG. 1 according to one or more example implementations of the disclosure;

FIG. 5 is an example diagrammatic view of the machine learning (ML) model according to one or more example implementations of the disclosure; and

FIG. 6 is an example diagrammatic view of the gearshift deduplication process of FIG. 1 according to one or more example implementations of the disclosure.

Like reference symbols in the various drawings indicate like elements.

### DETAILED DESCRIPTION

### System Overview:

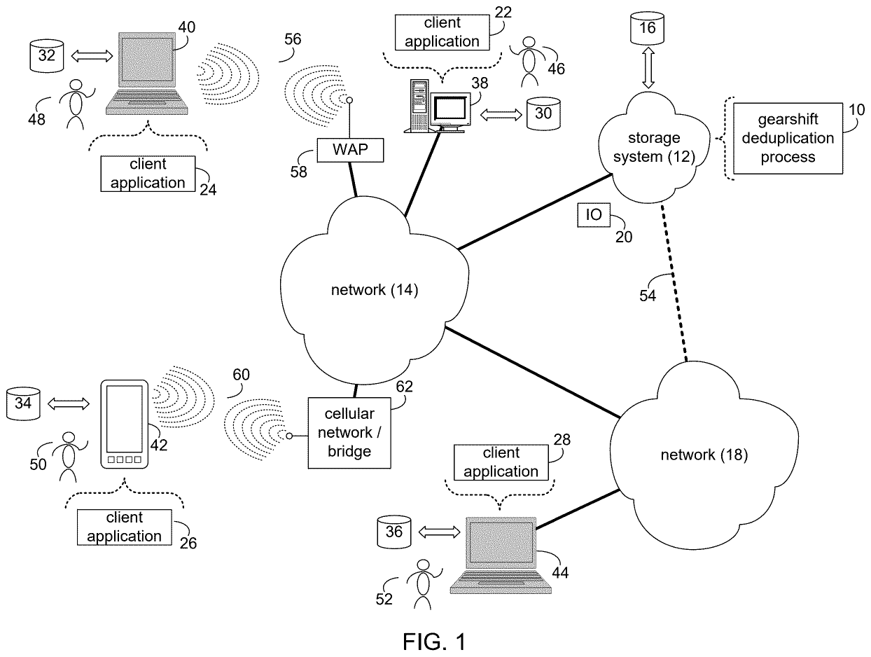

Referring to FIG. 1, there is shown gearshift deduplication process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of gearshift deduplication process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of gearshift deduplication process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a deduplication management process, such as gearshift deduplication process 10 of FIG. 1, may include but is not limited to, tracing a variable set of deduplication metrics for one or more deduplication data sets, applying a regression-based machine learning (ML) model to the variable set of deduplication metrics in order to generate one or more of a weighted deduplication score and a weighted compression score for each data set of the one or more deduplication data sets, and selecting one or more of a compression algorithm and a deduplication parameter based on one or more of the weighted deduplication score and the weighted compression score. The method may further include using a flushing manager to perform in-line deduplication on one or more selections of front-end IO write data and to apply one or more of the selected compression algorithm and the selected deduplication parameter.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

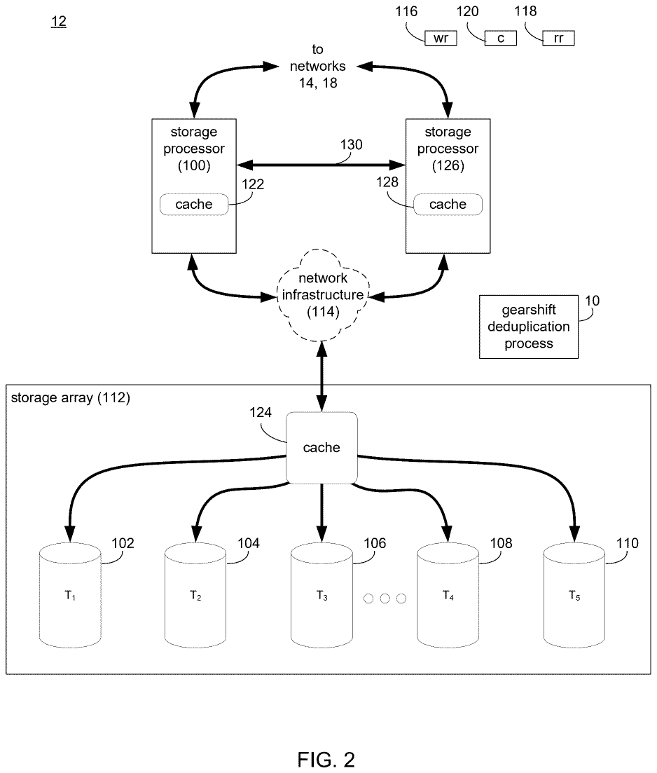

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g. storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g. the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of gearshift deduplication process 10. The instruction sets and subroutines of gearshift deduplication process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices. As discussed above, some portions of the instruction sets and subroutines of gearshift deduplication process 10 may be stored on storage devices (and/or executed by processors and memory architectures) that are external to storage system 12.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content be written to storage system 12) and data read request 118 (i.e. a request that content be read from storage system 12).

During operation of storage processor 100, content 116 to be written to storage system 12 may be processed by storage processor 100. Additionally/alternatively and when storage processor 100 is configured as an application server, content 116 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 116 within frontend cache memory system 122. Depending upon the manner in which frontend cache memory system 122 is configured, storage processor 100 may immediately write content 116 to data array 112 (if frontend cache memory system 122 is configured as a write-through cache) or may subsequently write content 116 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 116 to be written to data array 112 may be received from storage processor 100. Data array 112 may initially store content 116 within backend cache memory system 124 prior to being stored on e.g. one or more of storage targets 102, 104, 106, 108, and coded target 110.

As discussed above, the instruction sets and subroutines of gearshift deduplication process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of gearshift deduplication process 10 may be executed by one or more processors (not shown) and one or more memory architectures (not shown) included within data array 112.

Further and as discussed above, during the operation of data array 112, content (e.g., content 116) to be written to data array 112 may be received from storage processor 100 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 116 to be written to storage system 12 may be processed by storage processor 126. Additionally/alternatively and when storage processor 126 is configured as an application server, content 116 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 116 within frontend cache memory system 126. Depending upon the manner in which frontend cache memory system 128 is configured, storage processor 126 may immediately write content 116 to data array 112 (if frontend cache memory system 128 is configured as a write-through cache) or may subsequently write content 116 to data array 112 (if frontend cache memory system 128 is configured as a write-back cache).

In some implementations, the instruction sets and subroutines of gearshift deduplication process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of gearshift deduplication process 10 may be executed by one or more processors (not shown) and one or more memory architectures (not shown) included within data array 112.

Further and as discussed above, during the operation of data array 112, content (e.g., content 116) to be written to data array 112 may be received from storage processor 126 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where processing of data by one storage processor may be synchronized to the other storage processor. For example, data may be synchronized between each storage processor via a separate link or connection (e.g., connection 130).

### The Gearshift Deduplication Process:

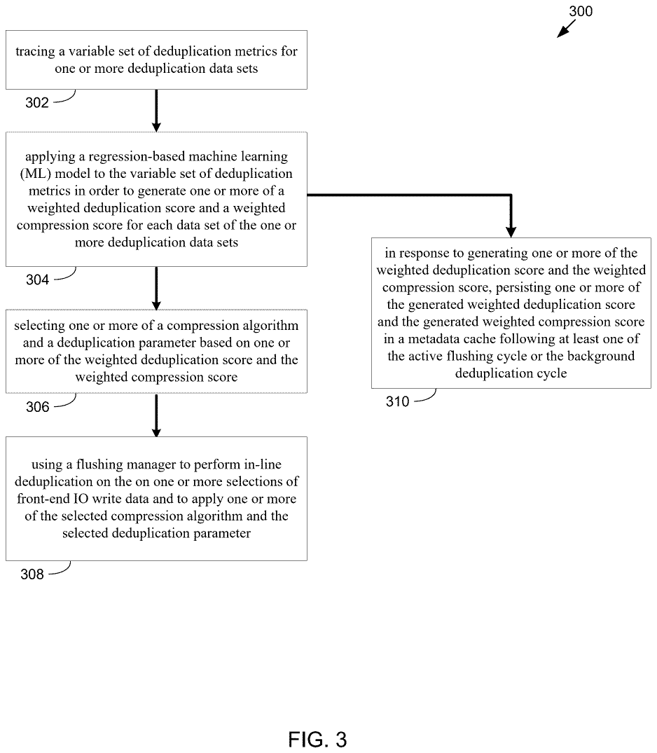

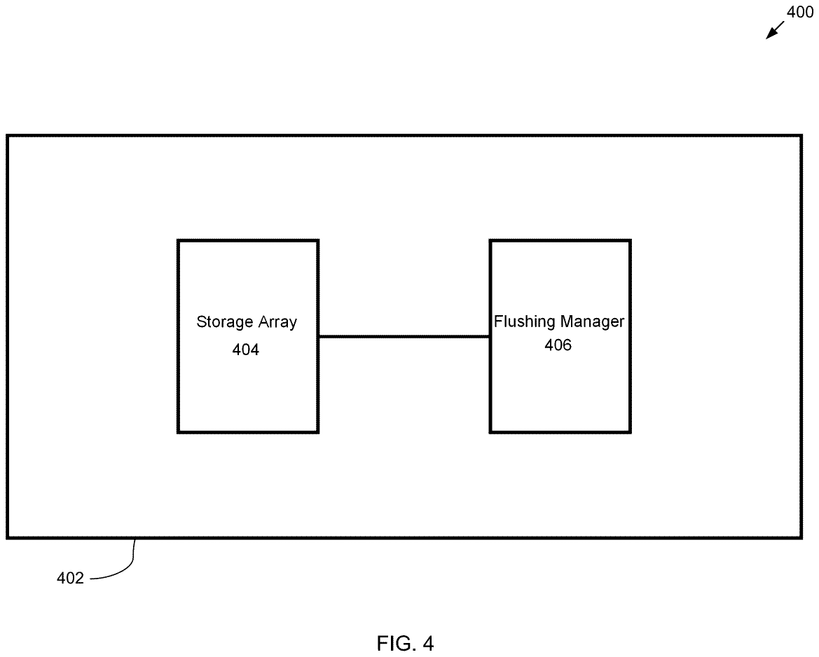

Referring also to FIGS. 3-4 and in some implementations, gearshift deduplication process 10 may trace (302) a variable set of deduplication metrics for one or more deduplication data sets, and apply (304) a regression-based machine learning (ML) model to the variable set of deduplication metrics in order to generate one or more of a weighted deduplication score and a weighted compression score for each data set of the one or more deduplication data sets. Gearshift deduplication process 10 may also select (306) one or more of a compression algorithm and a deduplication parameter based on one or more of the weighted deduplication score and the weighted compression score, and use (308) a flushing manager to perform in-line deduplication on one or more selections of front-end IO write data and to apply one or more of the selected compression algorithm and the selected deduplication parameter. In response to generating one or more of the weighted deduplication score and the weighted compression score, gearshift deduplication process 10 may further persist (310) one or more of the generated weighted deduplication score and the generated weighted compression score in a metadata cache following at least one of an active flushing cycle or a background deduplication cycle.

In some implementations, as will be discussed in greater detail below, gearshift deduplication process 10 may be used to autonomously turn deduplication on/off when flushing data to its final destination. Flushing refers to the process of writing data or metadata from temporary or in-memory storage (e.g., a cache or buffer) to permanent storage, such as disk or SSD. Turning off deduplication may allow the flushing cycle to be shorter, which in turn may boost performance during high front-end load, where the flushing cycle is the period during which flushing occurs, and a high front-end load refers to a high volume of read and write requests directed at a storage system's front-end processors or controllers. Gearshift deduplication process 10 may cause a flushing manager to turn on/off deduplication per flush process (i.e. flush thread), instead of relying on a single major switch to balance performance and data reduction ratio (DRR). DRR is a metric used to quantify the effectiveness of a deduplication process, often combined with compression, in reducing the amount of storage space required for data. More specifically, DRR is the ratio of the original data size to the size of the data after deduplication and compression.

Although relying on a single major switch may help with performance momentarily, this approach may have two significant deficiencies. The first deficiency may be that long-term performance may drop if the deferred deduplication debt reaches its upper limit. This usually comes into play if the deferred debt is too much to handle/clear during a low-demand load period. Deduplication debt may refer to the accumulation of redundant or non-deduplicated data within a storage system with deduplication capabilities but may not yet have applied the deduplication process to all stored data. The second deficiency may be that drive wear will occur faster than normal due to additional metadata and data updates required to process the deferred deduplication in the background.

Consider example 400, shown in FIG. 4, a SAN environment (e.g. SAN 402) may include a storage device (e.g. storage array 404) and a flushing manager (e.g. flushing manager 406). During a high input-output (IO) load period, if the deduplication ratio is 2:1 (meaning that deduplication effectively processes 2 GB of logical data to consume only 1 GB of storage capacity), with 50% skipping (meaning 50% of dedupable data is intentionally or automatically bypassed), a maximum deduplication debt may be set to ten times the amount of front-end IO write data (i.e. 10*IOPS_{write}). Furthermore, if the IOPS_{write} is normalized to a data cache page, and if flushing manager 406 is forced to perform 100% inline deduplication when the maximum deduplication debt is reached. Then the amount of deduplication debt accumulated in t seconds may be given by Equation 1 below:

$$Debt ( t ) = {\sum }_{0}^{t} \frac{1}{2} * \frac{1}{2} * 10 * IOPSwrite ( t ) . \qquad Equation 1$$

Then the maximum deduplication debt would be reached at t=40 seconds, which may lead to a significant performance drop.

In some implementations, gearshift deduplication process 10 may trace (302) a variable set of deduplication metrics for one or more deduplication data sets. Tracing refers to keeping track of a predetermined selection of attributes and performance metrics for a given chunk of front-end IOwrite data. For example, at the end of the flush cycle, gearshift deduplication process 10 may trace timestamp, extent/metadata address, deduplication ratio achieved (i.e. logical data size/physical data size), compression ratio achieved (i.e. original data size/compressed data), and the compression algorithm used. Similarly, at the end of the background deduplication cycle, gearshift deduplication process 10 may trace timestamp, extent/metadata address, and deduplication ratio achieved. In some implementations, the tracing component may switch between an active trace file and a frozen in-memory trace file after a set period in order to allow for the machine learning (ML)/analytics model to work on the frozen trace file.

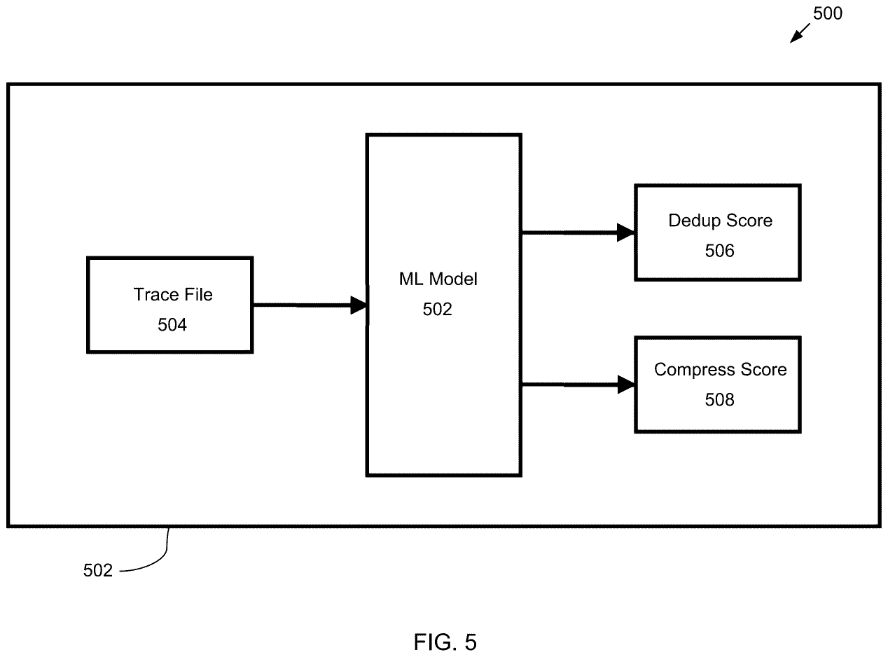

In some implementations and as shown in example 500 of FIG. 5, gearshift deduplication process 10 may apply (304) a regression-based machine learning model (e.g. ML model 502) to the variable set of deduplication metrics (e.g. trace file 504) in order to generate one or more of a weighted deduplication score (e.g. dedup score 506) and a weighted compression score (e.g. compress score 508) for each data set of the one or more deduplication data sets. ML model 502 may be a pre-trained regression model that is configured to take trace file 504 as input. More specifically, trace file 504 may include one or more of the deduplication hit ratio (i.e. the number of duplicate chunks/total number of incoming chunks), compression yield ratio (i.e. the efficiency of a compression process in reducing data size), overwrite rate (i.e. the amount of overwritten data/total data written), and the compression algorithm used for each extent of front-end IOwrite data. ML model 502 may then generate dedup score 506 and a compress score 508 for each of front-end IOwrite data flushed to back-end storage and/or deduped during a background deduplication cycle.

In some implementations, dedup score 506 and compress score 508 may then be stored in an in-memory index, which may include a data structure that stores indexing information directly in the system's random access memory (RAM), rather than on disk. Further, ML model 502 may be retrained if the prediction error (predicted deduplication savings-actual deduplication savings) is large. In some implementations, training of ML model 502 may be offloaded to a dedicated analytics engine on the storage array or cloud.

Gearshift deduplication process 10 may further include selecting (306) one or more of a compression algorithm and a deduplication parameter based on one or more of the weighted deduplication score and the weighted compression score. In some example embodiments, the compression algorithm and deduplication parameter selected may be based on maximizing the yield of the data block. A high-yielding data block may be one that contains a significant amount of redundant or repetitive data, allowing the deduplication algorithm to save a substantial amount of storage space when it eliminates those redundancies during a deduplication process (e.g., either during a flushing cycle or a background deduplication cycle). These data blocks are particularly valuable in deduplication because they may provide a high deduplication ratio. Conversely, a low-yielding data block may be one that contributes little or no data reduction during the deduplication process because it contains primarily unique or non-redundant data.

Referring again to FIGS. 4-5, gearshift deduplication process 10 may further include using (308) a flushing manager to perform in-line deduplication on one or more selections of front-end IO write data and to apply one or more of the selected compression algorithm and the selected deduplication parameter. The flushing manager may be an external agent, such as flushing manager 406, operatively connected to a storage device, such as storage array 404. Flushing manager 406 may be configured to autonomously activate/deactivate in-line deduplication based on dedup score 506 and compress score 508. In-line deduplication refers to a deduplication process that may occur in real-time, as data is being written into storage. In-line deduplication may identify and eliminate duplicate data before it is committed to the storage medium, ensuring that only unique data ends up being stored. This contrasts with post-process deduplication (e.g., background deduplication), where deduplication happens retroactively after the data has been written into storage.

In some implementations, in response to generating one or more of the weighted deduplication score and the weighted compression score, gearshift deduplication process 10 may persist (310) one or more of the generated weighted deduplication score (dedup score 506) and the generated weighted compression score (compress score 508) in a metadata cache following at least one of the active flushing cycle or the background deduplication cycle. In some implementations, flushing manager 504 may deploy a deeper compression algorithm on high-yielding extents and avoid using a more expensive compression algorithm on low-yielding extents. This scheme may help to reduce the load on the background process which may enhance longevity performance and reduce drive wear due to additional updates needed by background dedupe.

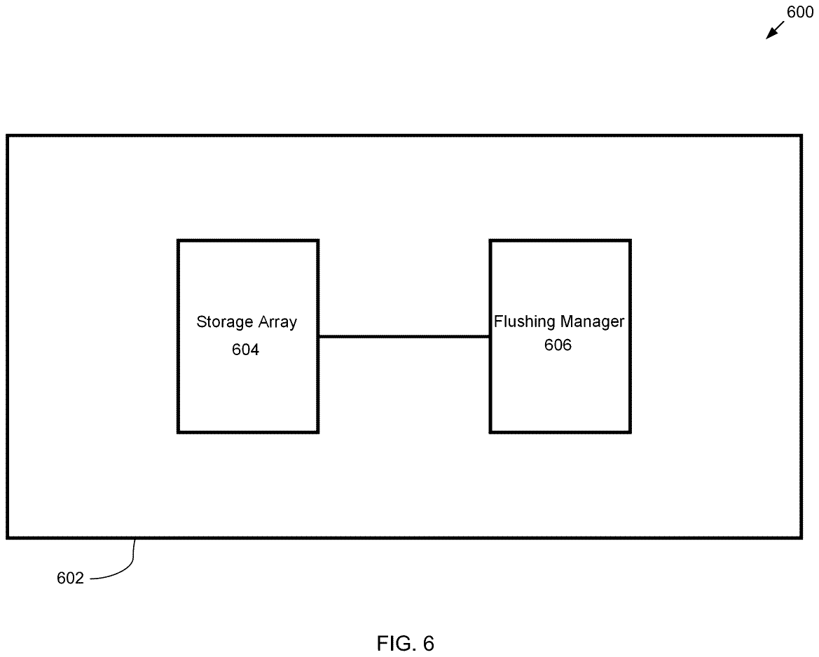

Consider example 600, shown in FIG. 6, a SAN environment (e.g. SAN 602) may include a storage device (e.g. storage array 604) and a flushing manager (e.g. flushing manager 606). During a high input-output (IO) load period, if the deduplication ratio is 2:1, with 50% skipping, a maximum deduplication debt may be set to be a thousand times the amount of front-end IO write data (i.e. 1,000*IOPS_{write}). Furthermore, if the IOPS_{write} is normalized to a data cache page, and flushing manager 406 may be forced to perform 100% inline deduplication when the maximum deduplication debt is reached. Then the amount of deduplication debt accumulated in t seconds may be given by Equation 2 below:

$$Debt ( t ) = {\sum }_{0}^{t} \frac{1}{2} * \frac{1}{2} * 1000 * IOPSwrite ( t ) . \qquad Equation 2$$

Then the maximum deduplication debt may be reached at t=4000 seconds, which may allow for longer bursts. Due to the efficiency of background deduplication of undedupable data (i.e data that does not include repeated or identical pieces of information that can be identified and eliminated through the process of deduplication), most of the data may be undedupable which in turn may allow gearshift deduplication process 10 to expand the amount of active deduplication debt. Undedupable data does not require metadata changes, and as such may significantly reduce the effect of drive wear on storage infrastructure.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

1. A computer-implemented method, executed on a computing device, comprising:
tracing a variable set of deduplication metrics for one or more deduplication data sets;
applying a regression-based machine learning (ML) model to the variable set of deduplication metrics in order to generate one or more of a weighted deduplication score and one or more of a weighted compression score for each data set of the one or more deduplication data sets;
selecting one or more of a compression algorithm and a deduplication parameter based on one or more of the weighted deduplication score and one or more of the weighted compression score;
receiving front-end IO write data;
using a flushing manager to perform in-line deduplication on one or more selections of the front-end IO write data and to apply one or more of the selected compression algorithm and the selected deduplication parameter to produce in-line deduplicated data; and
writing, by the flushing manager, the in-line deduplicated data to one or more storage targets.

2. The computer-implemented method of claim 1, wherein the regression-based ML model is configured to generate one or more of the weighted deduplication score and one or more of the weighted compression score for each data set of the one or more deduplication data sets.

3. The computer-implemented method of claim 1, wherein tracing occurs one or more of at the end of an active flushing cycle, and at the end of a background deduplication cycle.

4. The computer-implemented method of claim 3, further comprising:
in response to generating one or more of the weighted deduplication score and one or more of the weighted compression score, persisting one or more of the generated weighted deduplication score and the generated weighted compression score in a metadata cache following at least one of the active flushing cycle or the background deduplication cycle.

5. The computer-implemented method of claim 1, wherein the regression-based ML model is configured to integrate with the tracing process by recording one or more of a deduplication hit ratio, a compression yield ratio, and an overwrite rate.

6. The computer-implemented method of claim 1, wherein the variable set of deduplication metrics are related to one or more extents of back-end IO write data flushed from front-end IO write data.

7. The computer-implemented method of claim 1, wherein the variable set of deduplication metrics include one or more of a deduplication ratio and a compression ratio.

8. The computer-implemented method of claim 1, wherein the variable set of deduplication metrics includes one or more of: timestamps, metadata addresses, a number of flushes executed within the predefined time period, a metadata retention rate, a data integrity validation rate, and a recovery time.

9. A computer program product residing on a non-transitory computer readable medium having a plurality of instructions stored thereon which, when executed by a processor, cause the processor to perform operations comprising:
tracing a variable set of deduplication metrics for one or more deduplication data sets;
applying a regression-based machine learning (ML) model to the variable set of deduplication metrics in order to generate one or more of a weighted deduplication score and one or more of a weighted compression score for each data set of the one or more deduplication data sets;
selecting one or more of a compression algorithm and a deduplication parameter based on one or more of the weighted deduplication score and one or more of the weighted compression score;
receiving front-end IO write data
using a flushing manager to perform in-line deduplication on one or more selections of the front-end IO write data and to apply one or more of the selected compression algorithm and the selected deduplication parameter to produce in-line deduplicated data; and
writing, by the flushing manager, the in-line deduplicated data to one or more storage targets.

10. The computer program product of claim 9, wherein the regression-based ML model is configured to generate one or more of the weighted deduplication score and one or more of the weighted compression score for each data set of the one or more deduplication data sets.

11. The computer program of claim 9, wherein tracing occurs one or more of at the end of an active flushing cycle, and at the end of a background deduplication cycle.

12. The computer program product of claim 11, further comprising:
in response to generating one or more of the weighted deduplication score and one or more of the weighted compression score, persisting one or more of the generated weighted deduplication score and the generated weighted compression score in a metadata cache following at least one of the active flushing cycle or the background deduplication cycle.

13. The computer-implemented method of claim 9, wherein the regression-based ML model is configured to integrate with the tracing process by recording one or more of a deduplication hit ratio, a compression yield ratio, and an overwrite rate.

14. The computer-implemented method of claim 9, wherein the variable set of deduplication metrics are related to one or more extents of back-end IO write data flushed from front-end IO write data.

15. The computer-implemented method of claim 9, wherein the variable set of deduplication metrics include one or more of a deduplication ratio and a compression ratio.

16. A computing system comprising:
a memory; and
a processor configured to trace a variable set of deduplication metrics for one or more deduplication data sets, apply a regression-based machine learning (ML) model to the variable set of deduplication metrics in order to generate one or more of a weighted deduplication score and one or more of a weighted compression score for each data set of the one or more deduplication data sets, select one or more of a compression algorithm and a deduplication parameter based on one or more of the weighted deduplication score and one or more of the weighted compression score, receive front-end IO write data, use a flushing manager to perform in-line deduplication on one or more selections of the front-end IO write data and to apply one or more of the selected compression algorithm and the selected deduplication parameter to produce in-line deduplicated data, and write, by the flushing manager, the in-line deduplicated data to one or more storage targets.

17. The computing system of claim 16, wherein the regression-based ML model is configured to generate one or more of the weighted deduplication score and one or more of the weighted compression score for each data set of the one or more deduplication data sets.

18. The computing system of claim 16, wherein tracing occurs one or more of at the end of an active flushing cycle, and at the end of a background deduplication cycle.

19. The computing system of claim 18, further comprising:
in response to generating one or more of the weighted deduplication score and one or more of the weighted compression score, persisting one or more of the generated weighted deduplication score and the generated weighted compression score in a metadata cache following at least one of the active flushing cycle or the background deduplication cycle.

20. The computing system of claim 16, wherein the regression-based ML model is configured to integrate with the tracing process by recording one or more of a deduplication hit ratio, a compression yield ratio, and an overwrite rate.
